(19) United States
(12) Patent Application Publication
(10) Pub. No.: US 2014/0190583 A1
(43) Pub. Date: Jul. 10, 2014

(54) REPLACEABLE CIRCULATING LIQUID SUPPLEMENTING DEVICE AND LIQUID SUPPLEMENTING UTENSIL HAVING THE SAME

(71) Applicant: Bing PU, Dongguan (CN)

(72) Inventor: Bing PU, Dongguan (CN)

(21) Appl. No.: 13/807,750

(22) PCT Filed: Oct. 11, 2011
(86) PCT No.: PCT/CN11/80669

§ 371 Date: Dec. 31, 2012

(30) Foreign Application Priority Data
Sep. 7, 2011 (CN) 201120334344.8

(51) Int. Cl. B67C 3/28

(52) U.S. Cl. CPC B67C 3/28
USPC 137/798

(57) ABSTRACT

The replaceable circulating liquid supplementing device comprising a guide pillar, a spring, a supplementing mat, a sealing ring, a liner and an external member matched with a container utensil, wherein the liner and the external member are fixedly assembled; the guide pillar is assembled in the liner; one end of the guide pillar is provided with a limit block while the other end is provided with a groove; a flow pass is arranged in the middle of the guide pillar; the supplementing mat is hermetically arranged in the groove; one end of the flow pass passes through the supplementing mat, as a liquid inlet, while the other end of the flow pass is provided with a liquid outlet; the spring is sleeved on the outer wall of the guide pillar; and the sealing ring is arranged at one end of the guide pillar near the limit block.

### TECHNICAL FIELD OF THE INVENTION

The disclosure relates to the technical field of liquid containing devices, and in particular to a replaceable circulating liquid supplementing device and a liquid supplementing utensil having the same. This application is based on the application of a Chinese invention patent which is applied on Sep. 7, 2011 and of which the application number is 201120334344.8. The content of the patent application above is introduced into this application as reference.

### BACKGROUND OF THE INVENTION

At present, most devices or utensils for containing liquids have no liquid supplementing function. When the liquid in a containing bottle is used up, it is difficult to supplement the liquid for the second time or more times, thus great waste is caused.

In order to save resources and to recycle liquid spraying devices or utensils, people have developed a liquid supplementing bottle having a liquid supplementing device. The liquid supplementing bottle is obtained by setting a liquid supplementing device at the bottom of a conventional liquid spraying bottle; when the liquid in the liquid supplementing bottle is used up, the liquid contained in a mother bottle is pressed into the containing bottle through the liquid supplementing device, thus, cyclic utilization of the liquid supplementing bottle is realized.

In the conventional art, main parts of the liquid supplementing device mostly are arranged inside the containing bottle; consequently, the liquid is easy to suffer secondary pollution from these parts when entering the containing bottle, thus the quality of the liquid in the bottle is impacted and meanwhile the appearance is inaesthetic.

Since the liquid supplementing device needs to be provided with a gas guide tube in the conventional art, the containing bottle matched therewith often can only be provided with a special sprayer or shell and can not be matched with most general sprayers and shells, thus the practicality is low.

In addition, due to the defects of technique, the liquid supplementing device in the conventional art mostly are used to supplement water; other liquids with certain concentrations are difficult to be supplemented or can not be supplemented, that is, there are some limitations for the supplemented substances.

Therefore, in view of the defects existing in the conventional art, a replaceable circulating liquid supplementing device and a liquid supplementing utensil having the same are provided, which have advantages of good sealing, no-pollution and wide applicability and can supplement various liquids, to overcome the defects existing in the conventional art.

### SUMMARY OF THE INVENTION

The purpose of the disclosure is to provide a replaceable circulating liquid supplementing device to avoid the defects existing in the conventional art; the replaceable circulating liquid supplementing device has advantages of good sealing, no-pollution and wide applicability, and can supplement various liquids.

The above purpose of the disclosure is implemented by the following technical measures.

The disclosure provides a replaceable circulating liquid supplementing device, which is provided with a guide pillar, a spring, a supplementing mat, a sealing ring, a liner and an external member matched with a container utensil, wherein the liner and the external member are fixedly assembled; the guide pillar is assembled in the liner;

one end of the guide pillar is provided with a limit block while the other end is provided with a groove; a flow pass is arranged in the middle of the guide pillar;

the supplementing mat is hermetically arranged in the groove; one end of the flow pass passes through the supplementing mat, as a liquid inlet, while the other end of the flow pass is provided with a liquid outlet;

the spring is sleeved on the outer wall of the guide pillar; and

the sealing ring is arranged at one end of the guide pillar near the limit block.

The inner wall of the groove is provided with a recess, while the outer wall of the supplementing mat is provided with a convex button; the convex button is assembled in the recess.

The guide pillar is provided with a first limit surface and a second limit surface; the sealing ring is arranged between the first limit surface and the second limit surface; and

the liquid outlet is arranged between the first limit surface and the second limit surface.

The guide pillar is provided with a first terrace surface; and one end of the spring is pressed against the first terrace surface.

The liner is provided with a first step surface used for limiting the moving distance of the guide pillar and a second step surface used for pressing against the other end of the spring; the first step surface is arranged below the second step surface.

The linear is provided with a buckling hole; the external member is provided with a buckling part; and the buckling part is assembled in the buckling hole correspondingly.

Another purpose of the disclosure is to provide a liquid supplementing utensil having the replaceable circulating liquid supplementing device to avoid the defects existing in the conventional art; this liquid supplementing utensil can supplement liquids according to requirements, with advantages of good sealing, no-pollution, many types of liquids supplemented and wide applicability.

The above purpose of the disclosure is realized by the following technical means.

The disclosure provides a liquid supplementing utensil having the replaceable circulating liquid supplementing device, which is provided with a container utensil and the replaceable circulating liquid supplementing device mentioned above, wherein the replaceable circulating liquid supplementing device is fixedly assembled at the lower part of the container utensil.

The liquid supplementing utensil having the replaceable circulating liquid supplementing device is further provided with a head connection device, wherein the container utensil and the head connection device are set to be in screw-thread fit or snap fit or interference fit.

The head connection device is provided with an exhaust structure; and the exhaust structure is set to be a hole.

The head connection device is set to be a utensil cover or a sprayer;

when the head connection device is set to be an utensil cover, the hole is arranged on the utensil cover;

when the head connection device is set to be a sprayer, the hole is arranged on the sprayer.

A replaceable circulating liquid supplementing device of the disclosure is provided with a guide pillar, a spring, a supplementing mat, a sealing ring, a liner and an external member matched with a container utensil, wherein the liner and the external member are fixedly assembled; the guide pillar is assembled in the liner; one end of the guide pillar is provided with a limit block while the other end is provided with a groove; a flow pass is arranged in the middle of the guide pillar; the supplementing mat is hermetically arranged in the groove; one end of the flow pass passes through the supplementing mat, as a liquid inlet, while the other end of the flow pass is provided with a liquid outlet; the spring is sleeved on the outer wall of the guide pillar; and the sealing ring is arranged at one end of the guide pillar near the limit block. In this replaceable circulating liquid supplementing device, through the sealing match among the liner, the external member, the guide pillar and the supplementing mat, the liquid enters the flow pass from the liquid inlet of the guide pillar and flows out from the liquid outlet during the liquid supplementing process; since the supplemented liquid is infused to the container utensil from the liquid inlet through the flow pass directly, and the liquid does not contact other parts during the liquid supplementing process, the liquid would not be polluted during/before/after the liquid supplementing process. Moreover, this liquid supplementing device can be matched with various container utensils, with a wide application scope. Since the gas guide tube is avoided, a wide range of concentrations of liquids can be supplemented, thus the application scope is wide. In addition, the liquid supplementing device is simple in structure and low in cost.

The liquid supplementing utensil having the replaceable circulating liquid supplementing device can realize cyclic utilization through liquid supplement, and thus is more environmentally friendly. In the replaceable circulating liquid supplementing device, through the sealing match among the liner, the external member, the guide pillar and the supplementing mat, the liquid enters the flow pass from the liquid inlet of the guide pillar and flows out from the liquid outlet during the liquid supplementing process; since the supplemented liquid is infused to the container utensil from the liquid inlet through the flow pass directly, and the liquid does not contact other parts during the liquid supplementing process, the liquid in the container utensil would not be polluted during/before/after the liquid supplementing process, and the quality of the liquid in the container utensil is guaranteed. Since the gas guide tube is avoided, a wide range of concentrations of liquids can be supplemented, thus the application scope is wide. In addition, the liquid supplementing utensil having the replaceable circulating liquid supplementing device is simple in structure and low in cost.

### BRIEF DESCRIPTION OF THE DRAWINGS

The disclosure is further described by accompanying drawings below. However, the content in the accompanying drawings does not limit the disclosure.

FIG. 1 shows a structure diagram of a replaceable circulating liquid supplementing device of the disclosure; and

FIG. 2 shows a structure diagram of a liquid supplementing utensil having a replaceable circulating liquid supplementing device of the disclosure.

### DETAILED DESCRIPTION OF THE EMBODIMENTS

The disclosure is further described in conjunction with the following embodiments.

### Embodiment 1

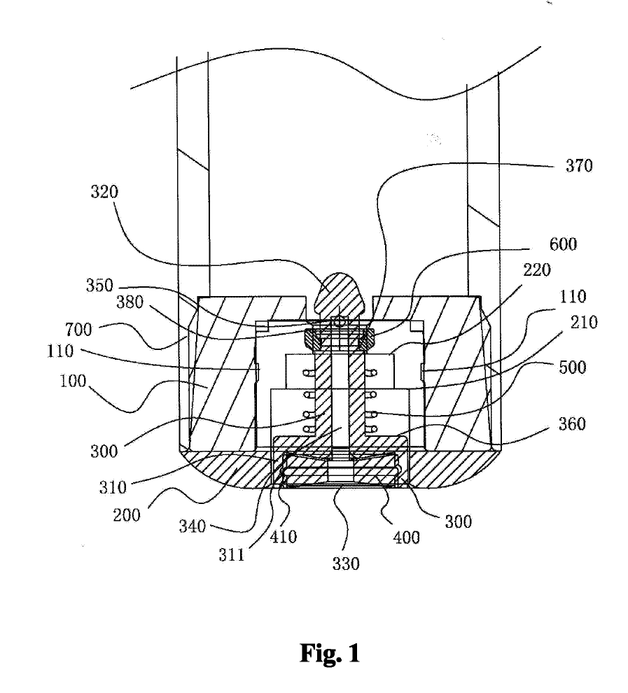

As shown in FIG. 1, a replaceable circulating liquid supplementing device is provided with a guide pillar 300, a spring 100, a supplementing mat 400, a sealing ring 600, a liner 200 and an external member 100 matched with a container utensil 700.

The liner 200 and the external member 100 are fixedly assembled; the guide pillar 300 is assembled in the liner 200. The liner 200 is provided with a buckling hole; the external member 100 is provided with a buckling part 110; the buckling part 110 is assembled in the buckling hole correspondingly to realize the fixed assembly between the external member 100 and the liner 200.

One end of the guide pillar 300 is provided with a limit block 320 while the other end is provided with a groove 310; a flow pass 340 is arranged in the middle of the guide pillar 300. The supplementing mat 400 is hermetically arranged in the groove 310; one end of the flow pass 340 passes through the supplementing mat 400, as a liquid inlet 330, while the other end of the flow pass 340 is provided with a liquid outlet 350.

The spring 500 is sleeved on the outer wall of the guide pillar 300; and the sealing ring 600 is arranged at one end of the guide pillar 300 near the limit block 320.

The inner wall of the groove 310 is provided with a recess 311, while the outer wall of the supplementing mat 400 is provided with a convex button 410; the convex button 410 is assembled in the recess 311 to realize the fixed match between the guide pillar 300 and the supplementing mat 400.

The guide pillar 300 is provided with a first limit surface 370 and a second limit surface 380; the sealing ring 600 is arranged between the first limit surface 370 and the second limit surface 380. The first limit surface 370 and the second limit surface 380 are used to limit the ascending sealing and the descending sealing of the sealing ring 600.

The liquid outlet 350 is arranged on the flow pass 340 between the first limit surface 370 and the second limit surface 380; when the guide pillar 300 is subject to an external force to move upwards, the guide pillar 300 moves upwards, the spring 500 is compressed and the liquid outlet 350 is exposed out of the sealing ring 600. When the external force is cancelled, the spring 500 drives the guide pillar 300 to return to the original position under the action of elastic force, and the liquid outlet 350 returns to the inside of the sealing ring 600.

The guide pillar 300 is provided with a first terrace surface 360; and one end of the spring 500 is pressed against the first terrace surface 360. The liner 200 is provided with a first step surface 210 and a second step surface 220, wherein the first step surface 210 is arranged below the second step surface 220; the other end of the spring 500 is pressed against the second step surface 220.

The first terrace surface 360 is used for limiting the position of the spring 500 to prevent the failure of the spring 500 caused by overpressure, and is used for pressing the spring 500 under stress. The second step surface 220 provided for the liner 200 is used for limiting the position of the other end of the spring 500.

The first step surface 210 provided for the liner 200 is used for limiting the moving distance of the guide pillar 300, thereby controlling the moving distance of the guide pillar 300 to be in a proper scope.

The working principle of the replaceable circulating liquid supplementing device of the disclosure is as follows: the replaceable circulating liquid supplementing device is assembled at the bottom of a container utensil 700; when the liquid inside the container utensil 700 is insufficient, a mother container utensil can be put under the replaceable circulating liquid supplementing device to supplement the liquid to the container utensil 700.

When the liquid is supplemented, an external force is exerted on the guide pillar 300, then the guide pillar 300 presses the spring 500, the first terrace surface 360 of the guide pillar 300 moves upwards and touches the first step surface 210 of the liner 200, two ends of the spring 500 are pressed against the first terrace surface 360 of the guide pillar 300 and the second step surface 220 of the liner 200 respectively, the liquid outlet 350 of the guide pillar 300 is exposed out of the sealing ring 600; at this moment, the liquid inside the mother container utensil is pressurized to flow from the liquid inlet 330 to the liquid outlet 350 through the guide pillar 300 and then into the container utensil 700, and later the spring 500 drives the guide pillar 300 to return to the original position under the action of restoring force. This cycle is repeated to pressurize and depressurize the guide pillar 300 for many times, so as to supplement the liquid inside the mother container utensil to the container utensil 700. As the liquid flows into the container utensil 700, the gas in the container utensil 700 is exhausted out via a utensil port of the container utensil 700.

In the replaceable circulating liquid supplementing device, through the sealing match among the liner 200, the external member 100, the guide pillar 300 and the supplementing mat 400, the liquid enters the flow pass from the liquid inlet 330 of the guide pillar 300 and flows out from the liquid outlet 350 during the liquid supplementing process; since the supplemented liquid is infused to the container utensil 700 from the liquid inlet 330 through the flow pass 340 directly, the flowing channel of the liquid is the flow pass only and the liquid does not contact other parts during the liquid supplementing process; therefore, during or after the liquid supplementing process, the liquid can be isolated from the main liquid supplementing parts to the greatest extent, thus no secondary pollution is caused to the liquid and the quality of the liquid is guaranteed.

This liquid supplementing device can be matched with various container utensils 700, with a wide application scope. Compared with the liquid supplementing device in the conventional art, this liquid supplementing device omits the gas guide tube and directly supplements the liquid to the container utensil 700; thus, this liquid supplementing device can supplement a wide range of concentrations of liquids, with a better appearance and a wider application scope.

In addition, this liquid supplementing device is simple in structure and low in cost.

It should be noted that the container utensil 700 matched with this replaceable circulating liquid supplementing device can be of different forms, materials and shapes, with strong practicality. The form includes bottles, pots, Tetra Brik and so on. The material of the container utensil 700 can include many materials such as plastic bottle, glass bottle, ceramic bottle or plastic pot, ceramic pot, also can be various containers made of paper. The shape of the container utensil 700 can be cylinder, ellipsoid, tetragonal body and cuboid, also can be other irregular shapes.

### Embodiment 2

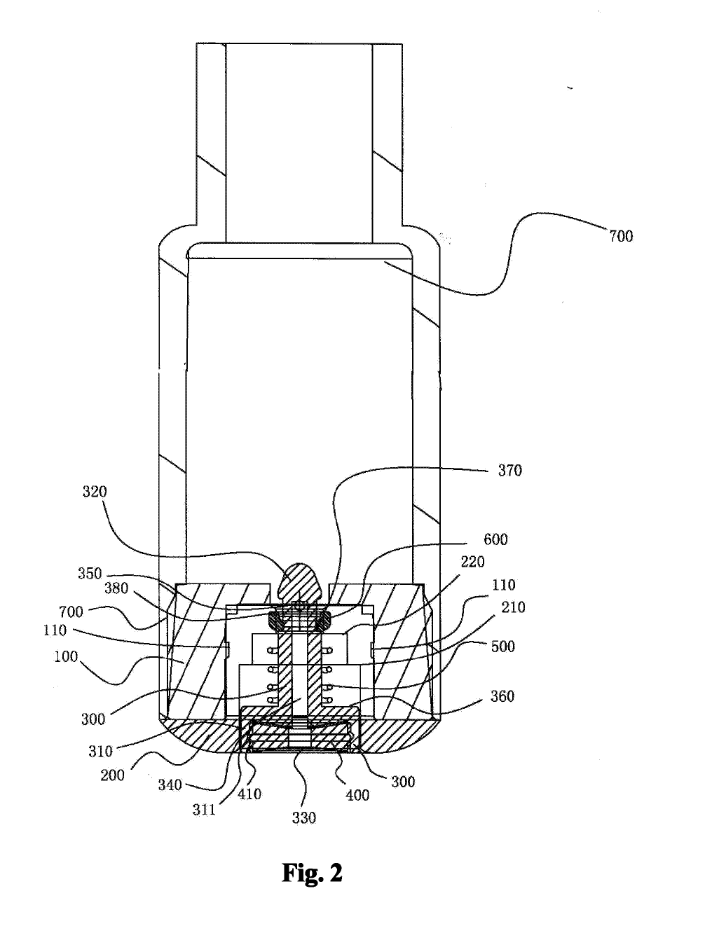

As shown in FIG. 2, a liquid supplementing utensil having a replaceable circulating liquid supplementing device is provided with a container utensil 700, a head connection device, the replaceable circulating liquid supplementing device mentioned in Embodiment 1 and a shell, wherein the shell is sleeved on the outside of the container utensil 700.

The replaceable circulating liquid supplementing device is fixedly assembled at the lower part of the container utensil 700; the head connection device is assembled at a utensil port of the container utensil 700. The container utensil 700 is matched with the head connection device through screw thread.

It should be noted that the fit mode between the container utensil 700 and the head connection device is not limited to the screw-thread fit mentioned in this embodiment, but can be other fitting modes, for example, snap fit or interference fit or other fit modes.

Since the replaceable circulating liquid supplementing device is assembled at the bottom of the container utensil 700, when the liquid inside the container utensil 700 is insufficient, a mother container utensil can be put under the replaceable circulating liquid supplementing device to supplement the liquid to the container utensil 700.

When the liquid is supplemented, a spraying nozzle of the mother container utensil is aligned to the liquid inlet 330 of the replaceable circulating liquid supplementing device and an external force is exerted to the guide pillar 300, then the guide pillar 300 presses the spring 500, the first terrace surface 360 of the guide pillar 300 moves upwards and touches the first step surface 210 of the liner 200, two ends of the spring 500 are pressed against the first terrace surface 360 of the guide pillar 300 and the second step surface 220 of the liner 200 respectively, the liquid outlet 350 of the guide pillar 300 is exposed out of the sealing ring 600; at this moment, the liquid inside the mother container utensil is pressurized to flow from the liquid inlet 330 to the liquid outlet 350 through the guide pillar 300 and then into the container utensil 700, and then the spring 500 drives the guide pillar 300 to return to the original position under the action of restoring force. This cycle is repeated to pressurize and depressurize the guide pillar 300 for many times, so as to supplement the liquid inside the mother container utensil to the container utensil 700. As the liquid flows into the container utensil 700, the gas in the container utensil 700 is exhausted out via the head connection device of the container utensil 700.

The head connection device can be self-provided with an exhaust structure, wherein the exhaust structure can be a hole; when the liquid is supplemented, the gas inside the container utensil 700 is exhausted out via the hole, so that the liquid can be supplemented into the container utensil 700.

The head connection device also can have no exhaust structure; in this way, when the liquid is supplemented, it is only needed to take the head connection device off the container utensil 700, then the gas is exhausted out via the utensil port of the container utensil 700, so that the liquid can be supplemented into the container utensil 700.

It should be noted that the head connection device can be set to be a sprayer or a common utensil cover. When the head connection device is set to be a utensil cover, the hole is arranged on the utensil cover; during the liquid supplementing process, the gas inside the container utensil is exhausted out via the hole on the utensil cover. When the head connection device is set to be a sprayer, the hole is arranged on the sprayer; during the liquid supplementing process, the gas inside the container utensil is exhausted out via the hole on the sprayer.

For the utensil having a replaceable circulating liquid supplementing device, the replaceable circulating liquid supplementing device is sealed through the liner 200, the external member 100, the guide pillar 300 and the supplementing mat 400; during the liquid supplementing process, the liquid enters the flow pass 340 from the liquid inlet 330 of the guide pillar 300 and flows out from the liquid outlet 350; since the supplemented liquid is infused to the container utensil 700 from the liquid inlet 330 through the flow pass 340 directly, the flowing channel of the liquid is the flow pass only and the liquid does not contact other parts during the liquid supplementing process; therefore, during or after the liquid supplementing process, the liquid can be isolated from the main liquid supplementing parts to the greatest extent, thus no secondary pollution is caused to the liquid and the quality of the liquid is guaranteed.

Since the gas guide tube is avoided and the supplemented liquid is directly infused into the container utensil 700, the liquid supplement utensil can supplement a wide range of concentrations of liquids, with a better appearance and a wider application scope.

In addition, the liquid supplement utensil having the replaceable circulating liquid supplementing device is simple in structure and low in cost.

### Embodiment 3

A liquid supplement utensil having a replaceable circulating liquid supplementing device is provided, which has a structure similar to Embodiment 2, wherein the difference lies in that this liquid supplement utensil has no shell and the head connection device is set to be a utensil cover. When the liquid inside the utensil is used up, the liquid can be supplemented through the replaceable circulating liquid supplementing device; during the liquid supplementing process, the utensil cover is opened to guarantee that the gas inside the utensil is exhausted in time, so that the liquid can be supplemented to the utensil. After the liquid is supplemented, the utensil cover is covered. The replaceable circulating liquid supplementing device is applicable to the liquid supplementing utensil without a sprayer and thus has a wide application scope.

It should be noted that the head connection device can be self-provided with an exhaust structure, wherein the exhaust structure specifically is a hole and the hole is arranged on the utensil cover. When the liquid is supplemented, the gas inside the container utensil is exhausted out via the hole on the utensil cover.

Finally, it should be noted that the embodiments above are only used to illustrate the technical scheme of the disclosure, but to limit the scope of protection of the disclosure; although the disclosure is described in detail by reference to preferred embodiments, those skilled in the art should understand that modifications or equivalent substitutes can be made to the technical scheme of the disclosure without departing from the essence and scope of the technical scheme of the disclosure.

### INDUSTRIAL APPLICABILITY

In the replaceable circulating liquid supplementing device and the liquid supplementing utensil having the replaceable circulating liquid supplementing device provided by the disclosure, through the sealing match among the liner, the external member, the guide pillar and the supplementing mat, the liquid enters the flow pass from the liquid inlet of the guide pillar and flows out from the liquid outlet during the liquid supplementing process; since the supplemented liquid is infused to the container utensil from the liquid inlet through the flow pass directly, and the liquid does not contact other parts during the liquid supplementing process, the liquid would not be polluted during/before/after the liquid supplementing process. Moreover, this liquid supplementing device can be matched with various container utensils, with a wide application scope. In addition, the replaceable circulating liquid supplementing device and the liquid supplementing utensil having the replaceable circulating liquid supplementing device are simple in structure and low in cost, with a good market prospect.

What is claimed is:

1. A replaceable circulating liquid supplementing device, comprising a guide pillar, a spring, a supplementing mat, a sealing ring, a liner and an external member matched with a container utensil, wherein
the liner and the external member are fixedly assembled; the guide pillar is assembled in the liner;
one end of the guide pillar is provided with a limit block while the other end is provided with a groove; a flow pass is arranged in the middle of the guide pillar;
the supplementing mat is hermetically arranged in the groove; one end of the flow pass passes through the supplementing mat, as a liquid inlet, while the other end of the flow pass is provided with a liquid outlet;
the spring is sleeved on the outer wall of the guide pillar; and
the sealing ring is arranged at one end of the guide pillar near the limit block.

2. The replaceable circulating liquid supplementing device according to claim 1, wherein the inner wall of the groove is provided with a recess, while the outer wall of the supplementing mat is provided with a convex button; the convex button is assembled in the recess.

3. The replaceable circulating liquid supplementing device according to claim 2, wherein the guide pillar is provided with a first limit surface and a second limit surface; the sealing ring is arranged between the first limit surface and the second limit surface; and the liquid outlet is arranged between the first limit surface and the second limit surface.

4. The replaceable circulating liquid supplementing device according to claim 3, wherein the guide pillar is provided with a first terrace surface; and one end of the spring is pressed against the first terrace surface.

5. The replaceable circulating liquid supplementing device according to claim 4, wherein the liner is provided with a first step surface used for limiting the moving distance of the guide pillar and a second step surface used for pressing against the other end of the spring; the first step surface is arranged below the second step surface.

6. The replaceable circulating liquid supplementing device according to claim 5, wherein the linear is provided with a buckling hole; the external member is provided with a buckling part; and the buckling part is assembled in the buckling hole correspondingly.

7. A liquid supplementing utensil having the replaceable circulating liquid supplementing device according to claim 6, comprising a container utensil and the replaceable circulating liquid supplementing device, wherein the replaceable circulating liquid supplementing device is fixedly assembled at the lower part of the container utensil.

8. The liquid supplementing utensil according to claim 7, which is further provided with a head connection device, wherein the container utensil and the head connection device are set to be in screw-thread fit or snap fit or interference fit.

9. The liquid supplementing utensil according to claim 8, wherein the head connection device is provided with an exhaust structure; and the exhaust structure is set to be a hole.

10. The liquid supplementing utensil according to claim 9, wherein the head connection device is set to be a utensil cover or a sprayer; when the head connection device is set to be a utensil cover, the hole is arranged on the utensil cover; when the head connection device is set to be a sprayer, the hole is arranged on the sprayer.
